(19) United States
(12) Patent Application Publication
(10) Pub. No.: US 2011/0199264 A1
(43) Pub. Date: Aug. 18, 2011

(54) Printed Blinds Styled TV or Radio Antenna

(76) Inventor: Frank Chen, Walnut, CA (US)

(21) Appl. No.: 12/705,745

(22) Filed: Feb. 15, 2010

(51) Int. Cl. H01Q 1/38

(52) U.S. Cl. 343/700 MS

(57) ABSTRACT

Present invention uses conductive ink to print blinds style conductor group onto a flat dielectric substrate to form a TV or radio antenna. The antenna reception area is formed by printed blinds style conductor groups connected by a conductor collector printed across, and a hole near one side of said conductor collector, allowing users to connect either 75Ω coaxial cable to the TV connector or 300Ω twin lead wire to the radio terminal.

### FIELD AND BACKGROUND OF THE INVENTION

The present invention relates to modular design for a TV or Radio antenna by printing conductive ink onto a generally flat dielectric substrate, forming a TV or radio signal reception area consisting of blinds style conductor group with conductors collector, to provide the reception capability for the VHF and UHF frequency (30 MHz-3 GHz) TV signal and AM (350 KHz-1,700 KHz) or FM (88 MHz-108 MHz) radio broadcasting.

### OBJECTS AND SUMMARY OF THE INVENTION

Present invention provides high efficiency antenna for TV or Radio signal reception. The printed blinds style antenna of present invention uses printed conductive ink onto flat panel made of light dielectric material and allows easy user set up. Moreover, this antenna requires no power source, such as batteries, or any AC to DC power adapters.

### DESCRIPTION OF THE DRAWINGS

The accompanying drawings, which are incorporated in and constitute a part of this specification, illustrate the preferred embodiments of the invention and together with the description, serve to explain the principles of the invention, but are not intended to limit the scope of present invention to the extent present invention is applicable.

FIG. 1 shows the overall structure for present invention of printed blinds style antenna for TV or Radio.

### DETAILED DESCRIPTION OF THE PREFERRED EMBODIMENT

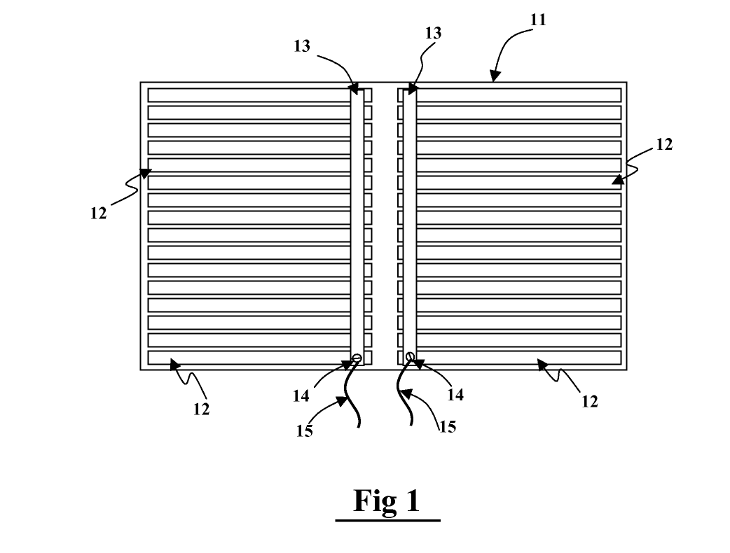

The antenna of present application consists of two printed blinds style conductor groups formed by the parallel printed strips (FIG. 1, 12) where each group has a conductors collector (FIG. 1, 13). These strips (FIG. 1, 12) and conductors collector (FIG. 1, 13) are formed by printing conductive ink to a rectangle flat dielectric substrate.

Said conductor collector (FIG. 1, 13) is printed across the conductor groups (FIG. 1, 12) to form one unit of signal receiver. There is no specific requirement for the angle between said conductors collector (FIG. 1, 13) and conductor strips (FIG. 1, 12) when said conductors collector (FIG. 1, 13) is printed across the conductor strips, as long as said conductor strips (FIG. 1, 12) are connected by said conductor collector (FIG. 1, 13).

Each conductor collector (FIG. 1, 13) has a hole (FIG. 1, 14) at one end, for connecting to signal wires (FIG. 1, 15) either for 75Ω coaxial cable, or 300Ω twin lead wire.

What is claimed is:

1. A printed blinds style TV or Radio antenna, comprising conductive ink printed onto a flat dielectric substrate to form blinds style conductor group, with conductor group collector strip printed across said blinds style conductor group.

2. A printed blinds style TV or Radio antenna, comprising two group of conductive ink printed onto a dielectric substrate to form blinds style conductors groups, with conductor group collector strip printed across said blinds style conductor groups.
